(19) United States
(12) Patent Application Publication
(10) Pub. No.: US 2011/0167982 A1
(43) Pub. Date: Jul. 14, 2011

(54) Acoustical Device For Drum

(76) Inventor: Eric Schmidt, Wichita, KS (US)

(21) Appl. No.: 12/986,781

(22) Filed: Jan. 7, 2011

Related U.S. Application Data
(60) Provisional application No. 61/295,074, filed on Jan. 14, 2010.

(51) Int. Cl. G10D 13/02

(52) U.S. Cl. 84/411 R

(57) ABSTRACT

Disclosed is a device which is designed to improve the accoustics of a drum. The device has two halves, and it attaches about a hole formed in the drum head. One or both halves have portions which can be flared to a variety of degrees, e.g., 90 degrees, 180 degrees, 360 degrees or more.

### RELATED APPLICATIONS

This application claims the benefit of U.S. Provisional Application No. 61/295,074 filed Jan. 14, 2010 and the contents of that application are herein incorporated by reference.

### BACKGROUND

1. Field of the Invention

Generally the invention relates to devices which operate with musical drums to improve sound quality. More specifically, the invention relates to devices that affect the release of air from the body of the musical drum as well as the transmission of sound waves from the drum upon the striking of the drum head.

2. Description of the Related Art

Numerous processes exist in the prior art which tune or adjust the audio output from a drum arrangement. Some drums, for example, bass drums, typically operate with a resonating head which resonate upon the striking of the striking head of the drum. Initially, the resonate head vibrates because of a displacement of the air inside the drum chamber. Other vibration is transferred through the surrounding drum structure to the resonate head.

It is known to change the sound characteristics of a bass drum using a cylindrically-shaped insert. See, for example, U.S. Pat. No. 7,582,820 issued to Millender, Jr., et al. Millender uses his cylindrical insert to maximize the punch of the bass drum as well as minimize ringing. The device is inserted into a circular opening created in the resonate head of the drum.

In another patent, U.S. Pat. No. 6,700,044, issued to Bencomo, Jr., a removable blocking member is provided which allows the user to selectively restrict the passage of air through the resonate drum head or remove a cover to expose an aperture to change the acoustical characteristics.

### BRIEF DESCRIPTION OF THE DRAWINGS

FIG. 1 shows a sectional view with a drum cut essentially front to back in half at the center axis for a first embodiment.

FIG. 2 shows a second sectional embodiment.

FIG. 3 shows a third sectional embodiment.

FIG. 4 shows a fourth sectional embodiment.

FIG. 5 shows a fifth sectional embodiment.

FIGS. 6-10 show embodiments which are very similar to the embodiments in FIGS. 1-5, except that a phase plug element is included.

### DETAILED DESCRIPTION OF THE DRAWINGS

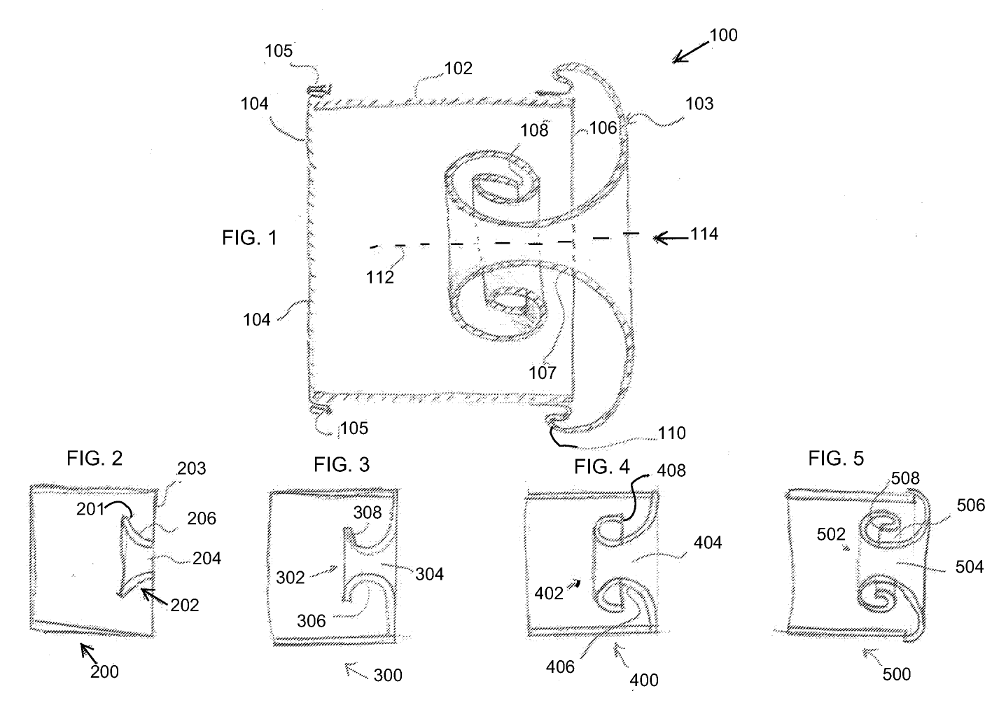

The details of the disclosed embodiments are shown in FIGS. 1-5. Referring first to FIG. 1, it can be seen that a drum system 100 is useable with a conventional bass drum. Although the drum used herein is a bass drum, these technologies could apply to other kinds of drums. As is common, the drum includes a substantially cylindrical body 102 which has front and rear ends. Normally the drum has two heads (one for striking, and another is referred to at the resonating, or resonate head). A striking head 104 is what receives an impact from a foot driven mallet device as is well known in the field. The striking head 104 is secured using a fastening mechanism 105 about the periphery of the forward part of the drum. At a second end 106 of the drum, where a resonate head exists, an alternative device 103 has been installed by adhering it to the outside of the drum body 102 at the rear end 106. Embodiment 103 is fixed to the outside surface of the drum body 102 at a connection point 110 using adhesive or fasteners or some other technique.

In this embodiment, device 103 is made to be symmetrical about a center axis 112 of the drum. A port 114 is defined through the center of the device 103 (also around the central axis 112). The port 114 opens up the inner drum chamber 109 through the rear of the drum. The device 103 and port 114 both have center axii which are the same as drum center axis 112. In other words, in this embodiment, all share the same axis. Alternatively, however, the axis for the device 103, port 114, could be offset in parallel, or even skewed from the center axis. Thus, the invention should not be limited to any particular embodiment depicted unless so stated in the claims.

Structurally, device 103 includes a body 107 which, describing it from rear to front, curves slightly out from connection edge 110, then tapers inward. Then the body 107 flares outward to such an extreme that it makes about one and a half curls to conclude with a termination edge 108 which is now internal to the body 107.

FIG. 2 shows an alternative second embodiment of the disclosed drum. In this embodiment, a system 200 comprises a device 202 which is mounted onto a resonate head 203 and has an port 204 defined through the resonate head 203. Resonant head could be formed of Mylar or an equivalent material. Again, device 202 shares a central axis which is common with the overall drum. As can be seen, the body 206 of device 202 is flared inward until reaching a terminating point 208. With this and other embodiments, the insert device 202 could be inserted and secured using an arrangement like that disclosed in the Millender patent discussed above. It could also be simply adhered around a removed circle in the resonant head, or include a peripheral channel which receive an inside edge of a circular cut out in the resonant head. Alternatively, it could be formed integrally with a resonate drum cover. For example, back cover 203 could be formed integrally with insert device 202.

FIG. 3 discloses a third embodiment 300 which comprises a device 302 which takes the place of a resonate drum head like with the FIG. 1 embodiment. Again, insert 302 has the same center axis as the drum itself. Device 302 has a port 304 therethrough and, as can be seen in the Figure a body 306, which is flared first inward and then outward to a circular termination edge 308. Whereas FIG. 2 has a sort of trumpet configuration, this version flares both inward and outward once installed.

FIG. 4 shows a fourth alternative embodiment 400 in which a device 402 is attached to the back end of the drum instead of the traditional resonate drum head. As can be seen from FIG. 4, it also defines a port 404 therethrough which allows for the passage of air inward and outward. As can be seen in this embodiment, a body 406 is curved in even greater extent than that shown in FIG. 3, and a termination edge 408 is actually pointed towards the back end of the drum.

Referring now to FIG. 5, a fifth embodiment 500 is shown. Embodiment 500 includes a device 502 which is secured to the back end of the drum in the place of the resonance drum head. Device 502 includes a port. Like with all of the other prior embodiments, this device 502 has a central axis which is the same as the central axis for the drum itself. Although all of the embodiments in FIGS. 1-5 show arrangements in which the center axis of the port device (for example, devices 100, 200, 300, 400, 500), it should not be considered limiting that this is the case. It is certainly possible that alternative embodiments exist in which the device has an axis which is offset but parallel, or even skewed relative to the drum center axis.

It can be seen that a body 506 of the fifth embodiment is curled even to an extent greater than that shown in the FIGS. 2-4 embodiments, but less so than the FIG. 1 embodiment. Referring to the figure, it can be seen that body 506 tapers inward initially and then flares outward to such an extent that a termination edge 508 is pointing again in a forward direction relative to the drum. (Thus, one full curl once past the transition from tapering to flaring).

It has been shown the above configurations enhance the acoustics of the drum.

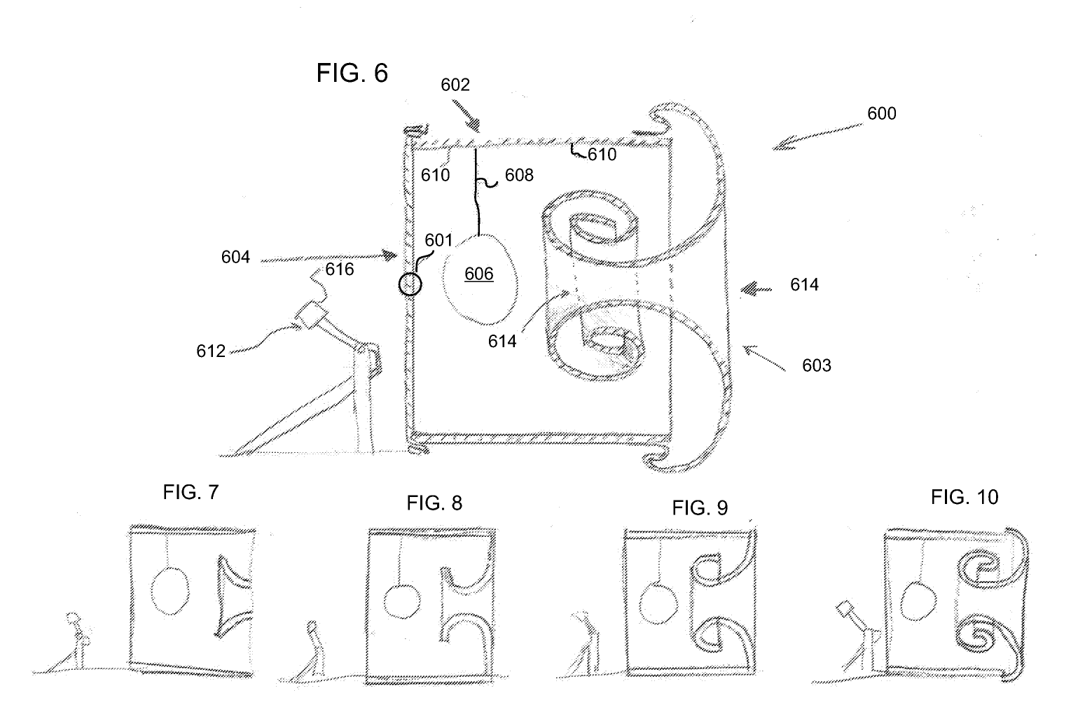

FIGS. 6-10 show embodiments in which occluding members are used to prevent direct which are very similar to the embodiments in FIGS. 1-5, except that a spherical phase plug element 606 is included. Referring to the FIG. 6 embodiment 600, it can be seen that interposed member 606 hangs from a string 608 or other suspension means. Alternatively it could be positioned using some securing or supporting arrangement. Member 606, in the disclosed embodiment, is positioned directly between the strike zone 601 on the forward head of the drum, and the port 614 of the insert 603. More specifically, in the disclosed embodiment, the center of member 606 is in the line between zone 601 where head 616 of the striker impacts, and the center axis of port 614. It is believed that the positioning of member 606 blocks the directional high frequency “tick” or “click” from the striker, and thus damps these undesirable sounds. By obstructing the direct line-of-audio transmission between the drum strikes and the phase plug 614, the audio of the drum is improved.

Although the interposed members (e.g., member 606) in each of FIGS. 6-10 is spherical, it might instead be shaped in numerous other ways so long as it is between the striked portion of the striker head and the rear end of the drum

As can be seen, the present invention and its equivalents are well-adapted to provide a new and useful drum. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will also be understood that certain features and subcombinations are of utility and may be employed without reference to other features and subcombinations and are contemplated within the scope of the claims. Not all steps listed in the various figures need be carried out in the specific order described.

I claim:

1. A device for changing an accoustical effect of a drum, the device comprising:
a first half defining a hole and flaring away from the drum head in a first direction;
a second half for installation on an opposite side of the drum head; and
means for attaching said first and second halves about a hole formed in the drum head.

2. The device of claim 1 wherein the second half also has a flared portion which extends away from the drum head in a direction opposite of which the first half flared portion extends.

3. The device of claim 1 wherein the flared portion on the first half has an edge which has been bent around to face a direction about 180 degrees in the opposite direction from that in which the flare originally begins.
